(19) United States
(12) Patent Application Publication
(10) Pub. No.: US 2025/0269593 A1
(43) Pub. Date: Aug. 28, 2025

(54) ROTATABLE PRINTHEAD FOR ELECTROHYDRODYNAMIC PROCESSES

(71) Applicant: University of Oregon, Eugene, OR (US)

(72) Inventors: Paul D. Dalton, Eugene, OR (US); Simon Luposchainsky, Eugene, OR (US); Iman von Briesen, Eugene, OR (US); Ievgenii Liashenko, Eugene, OR (US)

(73) Assignee: University of Oregon, Eugene, OR (US)

(21) Appl. No.: 19/066,796

(22) Filed: Feb. 28, 2025

Related U.S. Application Data
(60) Provisional application No. 63/559,149, filed on Feb. 28, 2024.

(51) Int. Cl. B29C 64/209; B29C 64/118; B33Y 10/00; B33Y 30/00

(52) U.S. Cl. CPC B29C 64/209; B29C 64/118; B33Y 10/00; B33Y 30/00

(57) ABSTRACT

A device includes a rotatable head and one or more fluid dispensers coupled to the rotatable head. The one or more fluid dispensers define multiple outlets. The one or more fluid dispensers are configured to eject polymer melts through the multiple outlets while rotating the rotatable head about an axis.

### CROSS REFERENCE TO RELATED APPLICATIONS

This application claims the benefit of U.S. Provisional Application No. 63/559,149, filed Feb. 28, 2024, which is incorporated by reference herein.

### FIELD

The present disclosure concerns systems and methods related to electrohydrodynamic processing technologies, including electrospinning and melt electrowriting.

### BACKGROUND

Electrohydrodynamic processes occur when a voltage is applied to a fluid, inducing charges that result in a product with enhanced properties. These processes include electrospinning, where electrical instabilities are generated by charges; electrowriting, where a fluid column is stabilized by charges; and electrospraying, where small particles are generated by charges on fluids with low surface tension. Despite the recent advancements in electrohydrodynamic processing technologies, there is still potential for improvement, particularly in the production of fibers with specific mechanical properties.

### SUMMARY

Described herein are apparatuses, systems, and methods for electrohydrodynamic technologies, which overcome one or more of the deficiencies of conventional electrohydrodynamic technologies.

Certain examples of the disclosure concern a device including a rotatable head and one or more fluid dispensers coupled to the rotatable head. The one or more fluid dispensers can define multiple outlets. The one or more fluid dispensers can be configured to eject polymer melts through the multiple outlets while rotating the rotatable head about an axis.

Certain aspects of the disclosure concern a system including a printhead configured to form polymer jets through multiple outlets, and a power supply configured to generate an electrostatic field between the multiple outlets and a substrate. The electrostatic field can be configured to electrically charge the polymer jets and direct the electrically charged polymer jets from the multiple outlets to the substrate. The printhead can be configured to cause the electrically charged polymer jets to intertwine before depositing on the substrate.

Certain aspects of the disclosure further concern a method including forming multiple polymer jets, electrically charging the polymer jets and directing the electrically charged polymer jets toward a substrate, and twisting the electrically charged polymer jets to deposit a multi-filament fiber on the substrate.

Certain aspects of the disclosure also concern an apparatus including a printhead head having multiple outlets and a pressure source configured to extrude polymer melts out of the printhead through the multiple outlets. The multiple outlets can be positioned on the printhead in such a close proximity that the polymer melts extruded through the multiple outlets merge into a shared molten polymer droplet. The polymer melts extruded through at least two of the outlets cab contain different polymer materials.

The technologies described herein can be used in a number of applications. For example, the technologies described herein can be used to produce nano-scale and multi-filament fibers or yarns that have a strong plasticity, a flexible structure, and a large surface area-volume ratio. Such fibers can be used for fabrication of filtration media, textiles, coating material for medical devices, biocompatible membranes for tissue engineering, among others.

The foregoing and other features and advantages of the disclosed technologies will become more apparent from the following detailed description, which proceeds with reference to the accompanying figures.

### BRIEF DESCRIPTION OF THE DRAWINGS

FIG. 1 depicts an example setup of a conventional electrohydrodynamic processing system.

FIG. 2 depicts an example setup of an electrohydrodynamic processing system comprising a rotatable head.

FIG. 2A schematically depicts a configuration where multiple closely positioned outlets on a printhead allows forming a shared molten polymer droplet, from which a single polymer jet containing different polymer materials can be created.

FIG. 3 depicts an example printhead assembly which can be used in the electrohydrodynamic processing system of FIG. 2.

FIG. 4A is a perspective view of the rotatable printhead included in the printhead assembly of FIG. 3.

FIG. 4B is a bottom view of the printhead of FIG. 4A.

FIG. 4C is a top view of the printhead of FIG. 4A.

FIG. 4D is a side view of the printhead of FIG. 4A.

FIG. 5A is a perspective view of a thermo-regulating device included in the print assembly of FIG. 3.

FIG. 5B is a top transparent view of the thermo-regulating device of FIG. 5A.

FIG. 5C is a side transparent view of the thermo-regulating device of FIG. 5A.

FIG. 5D is a top and front transparent view of the thermo-regulating device of FIG. 5A.

FIG. 6A depicts a rotatable printhead and three outlets included in a prototype electrohydrodynamic processing system, according to one example.

FIG. 6B depicts rotation of the printhead of FIG. 6A causes midair twisting of electrically charged polymer jets ejected from the three outlets.

FIG. 6C is scanning electron microscopic (SEM) photo of a fiber segment including three strands of filaments respectively formed by three polymer jets.

FIG. 6D schematically illustrates twisting of the three strands of filaments formed by three polymer jets to form the fiber segment of FIG. 6C.

FIG. 7 is a flowchart describing an example printing method.

FIG. 8 is a block diagram of an example computing system in which described technologies can be implemented.

### DETAILED DESCRIPTION

### General Considerations

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved. The technologies from any example can be combined with the technologies described in any one or more of the other examples. In view of the many possible examples to which the principles of the disclosed technology may be applied, it should be recognized that the illustrated examples are only preferred examples and should not be taken as limiting the scope of the disclosed technology.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art. Any theories of operation are to facilitate explanation, but the disclosed systems, methods, and apparatus are not limited to such theories of operation.

As used in this application and in the claims, the singular forms “a,” “an,” and “the” include the plural forms unless the context clearly dictates otherwise. Additionally, the term “includes” means “comprises.” Further, the terms “coupled” and “connected” generally mean electrically, electromagnetically, and/or physically (e.g., mechanically or chemically) coupled or linked and does not exclude the presence of intermediate elements between the coupled or associated items absent specific contrary language.

Directions and other relative references (e.g., inner, outer, upper, lower, top, bottom, etc.) may be used to facilitate discussion of the drawings and principles herein, but are not intended to be limiting. For example, certain terms may be used such as “inside,” “outside,” “interior,” “exterior,” and the like. Such terms are used, where applicable, to provide some clarity of description when dealing with relative relationships, particularly with respect to the illustrated examples. Such terms are not, however, intended to imply absolute relationships, positions, and/or orientations. For example, with respect to an object, an “upper” part can become a “lower” part simply by turning the object over. Nevertheless, it is still the same part and the object remains the same. As used herein, “and/or” means “and” or “or,” as well as “and” and “or.”

### Overview of Electrohydrodynamic Processing Technologies

Electrohydrodynamic processing is a method of producing micro-and/or nano-scale polymer fibers and particles using high voltage. Typical electrohydrodynamic processing techniques include electrospinning, electrowriting, and electrospraying.

Electrospinning is a fiber production method that uses electrical force to draw charged threads of polymer solutions or polymer melts into fiber diameters on the order of few micrometers or less. In general, electrospinning can be performed using either polymer melts (also known as “melt electrospinning”) or polymer solutions (also known as “solution electrospinning”). In solution electrospinning, a polymer of interest is solubilized or dissolved in a volatile solvent to form a polymer solution, which is electrospun, typically at room temperature, to produce fibers. In contrast to solution electrospinning, melt electrospinning does not need volatile solvents. Instead, a polymer of interest is heated above its melting point (also referred to as “melting temperature”) so as to become a polymer melt, which can be electrospun to produce fibers.

Electrowriting is a fiber production method that uses electrical forces to stabilize a fluid column, so that it does not break up into droplets due to Plateau-Raleigh instabilities. In general, electrowriting can be performed using either polymer melts (also known as “melt electrowriting”) or polymer solutions (also known as “solution electrowriting” or “electrohydrodynamic 3D printing”). In solution electrowriting, a polymer of interest is solubilized or dissolved in a volatile solvent to form a polymer solution, which is stabilized by the voltage, typically at room temperature, to produce fibers, typically in the order of 1 micron to 100 microns. In contrast to solution electrowriting, melt electrospinning does not need volatile solvents. Instead, a polymer of interest is heated above its melting temperature so as to become a polymer melt, which can be stabilized by an applied voltage to produce fibers, typically in the order of 0.3 microns to 100 microns.

Electrospraying is a particle production method that uses electrical forces to break up fluids into droplets by accelerating Plateau-Raleigh instabilities. In general, electrospraying can be performed using either polymer solutions (also known as “solution electrospraying”) or polymer melts (also known as “melt electrospraying”). In solution electrospraying, a polymer of interest is solubilized or dissolved in a volatile solvent to form a low-concentration polymer solution, which is destabilized by the voltage, typically at room temperature, to produce particles, typically in the order of 0.3 microns to 100 microns in diameter. In contrast to solution electrospraying, melt electrospraying does not need volatile solvents. Instead, a polymer of interest is heated above its melting temperature so as to become a polymer melt, which can be destabilized by an applied voltage to produce particles, typically in the order of 0.3 microns to 100 microns in diameter.

Although electrospinning, electrowriting, and electrospraying share similar configurations or system setups, they are based on different physical phenomena that define respective processes. For example, system parameters can be adjusted to enhance electrohydrodynamic phenomena that produce the physical object.

Common materials used in electrohydrodynamic processing include organic polymers in the form of either solutions or melts. The polymers used for electrohydrodynamic processing can be organic polymers, including both natural and synthetic polymers, such as polycaprolactone (PCL), polylactic acid (PLA), polylactic-co-glycolic acid (PLGA), DNA, silk fibroin, fibrinogens, dextran, chitin, chitosan, alginate, collagen, gelatin, etc.

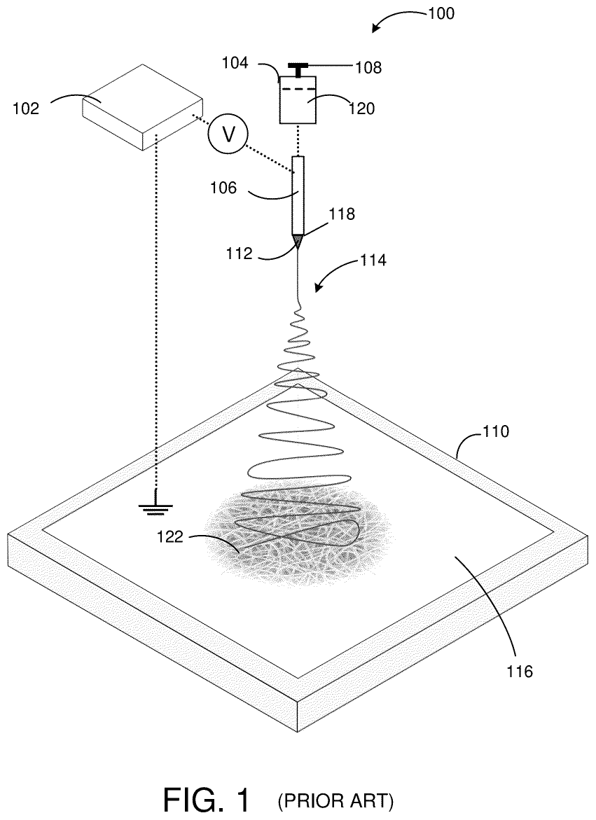

FIG. 1 depicts an example setup of a conventional electrohydrodynamic processing system 100, which can be used for solution electrospinning, melt electrospinning, solution electrowriting, melt electrowriting, solution electrospraying, melt electrospraying, etc. The electrohydrodynamic processing system 100 includes a high voltage power supply 102, a reservoir 104 which holds a liquid 120 of polymer solution or polymer melt, a nozzle 106 (also referred to as a “spinneret” or “needle”) in fluid communication with the reservoir 104, a pressure source or pressure supply 108 (e.g., a syringe pump, nitrogen canister, etc.), and a collector 110. Under the pressure of the pressure supply 108, the liquid 120 in the reservoir 104 can flow into the nozzle 106, and then be extruded out of an opening or orifice 118 located at a distal tip of the nozzle 106 by the pressure supply 108.

During electrohydrodynamic processing, the liquid 120 can be extruded from the nozzle 106 at a certain speed or flow rate under the control and propulsion of the pressure supply 108. The extruded liquid 120 can initially form a pendant droplet with a spherical shape due to surface tension. The power supply 102 can create an electrostatic field by applying a high voltage between the nozzle 106 and the collector 110. For example, the nozzle 106 can be positively charged and the collector 110 can be grounded, or vice versa. As another example, a differential voltage can be applied between the nozzle 106 and the collector 110, while neither the nozzle 106 nor the collector 110 is grounded. The electrostatic repulsion of the high voltage can stretch the droplet from its initial spherical shape to a conical shape, also known as a Taylor cone 112. When the voltage exceeds a given threshold, the electric field force can overcome the surface tension of the droplet and cause a charged jet 114 to be ejected from the Taylor cone 112.

During electrospinning, the charged jet 114 initially extends in a straight line and then undergoes chaotic whipping motions because of bending instabilities (also known as whipping instability). As the charged jet 114 is stretched into finer diameters, it solidifies quickly, leading to the deposition and collection of solid fiber(s) 122 on a substrate 116 situated on the collector 110. The accumulation of the fiber(s) 122 on the substrate 116 can form a fiber mesh or fiber membrane/film.

During electrowriting, the charged jet 114 is stabilized by the application of the high voltage. This occurs prior to the onset of electrohydrodynamic instabilities, leading to the deposition of fiber(s) 122 onto a substrate 116 located on the collector 110. The accumulated fiber(s) 122 on the substrate 116 can subsequently form a structured porous scaffold or a membrane.

During electrospraying, the application of high voltage causes the charged jet 114 to break up due to Plateau-Raleigh instabilities, leading to its fragmentation into particles or droplets of micro or nanoscale dimensions. These particles or droplets accumulate on the substrate 116 situated on the collector 110. They can either form a membrane or film, or maintain their individual droplet form.

In solution-based electrohydrodynamic processes (e.g., solution electrospinning, solution electrowriting, solution electrospraying, etc.), the liquid 120 is formed, typically at room temperature, by dissolving a polymer of choice in a volatile solvent, such as dimethylformamide (DMF), hexafluoroisopropanol (HFIP), trifluoroethanol (TFE), dichloromethane (DCM), chloroform (CHL), etc. As described herein, volatile solvents are liquids that can vaporize into a gas at the room temperature (e.g., between 15° C. and 40° C.) sufficiently rapidly so that polymer fibers or particles are formed. During the charged jetting process, rapid evaporation of the solvent can consolidate the charged jet into fiber(s) 122 (e.g., as in solution electrospinning or solution electrowriting) or break up the charged jet into particles (e.g., as in solution electrospraying). In some cases, residual solvent in the collected fiber(s) 122 can facilitate inter-fiber bonding that confers mechanical integrity to the resultant fiber mesh or membrane (or film).

In melt-based electrohydrodynamic processes (e.g., melt electrospinning, melt electrowriting, melt electrospraying, etc.), the liquid 120 is formed by heating a polymer of interest above its melting point so that the polymer is converted into a molten state, also known as a polymer melt. The polymer melt can then be extruded through the nozzle 106. The electrostatic field generated by the power supply 102 can be applied to the polymer melt as it exits the nozzle 106 and cause the polymer melt to elongate and solidify into fine fibers 122 (e.g., as in melt electrospinning or melt electrowriting) or break up into particles (e.g., as in melt electrospraying). Thus, unlike the solution-based electrohydrodynamic processes, the melt-based electrohydrodynamic processes eliminate the need for volatile solvents.

The aforementioned electrohydrodynamic processing technologies have been used in a variety of applications, such as fabricating nanofibrous scaffolds for tissue engineering applications, producing nanofibrous membranes with fine pores for filtration of particles and contaminants, printing three-dimensional (3D) structures with fine features and controlled porosity, creating microfluidic devices with precise flow control and biocompatibility, etc. Nonetheless, fibers or particles produced by existing electrohydrodynamic processing technologies often lack sufficient mechanical strength such that structural defects may occur in objects fabricated with those fibers. Additionally, fibers produced by existing electrohydrodynamic processing technologies generally contain the same polymer with monotonous properties which limit options to fabricate objects with various properties using such fibers.

The electrohydrodynamic processing technologies described herein not only can improve the mechanical strength of the produced fibers, but also can flexibly impart desired physical properties to the produced fibers or particles.

### Example Electrohydrodynamic Processing System with Rotatable Printhead

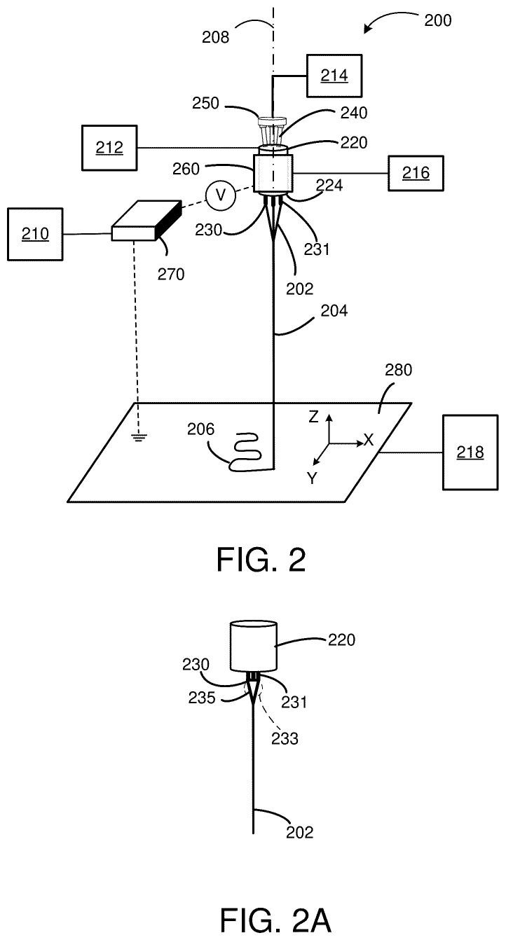

FIG. 2 schematically depicts (not drawn to scale) an example electrohydrodynamic processing system 200, according to certain aspects of disclosed technologies.

The electrohydrodynamic processing system 200 includes a printhead 220 (or simply “head”) which can be configured to spin or rotate about a longitudinal axis 208 of the printhead 220. For example, the printhead 220 can be operatively connected to a rotation controller 212 (e.g., a motor, or the like) configured to control the rotational speed and/or direction of the printhead 220. In some examples, the rotational speed of the printhead 220 can range from 0 to 10,000 RPM, inclusive. In one specific example, the rotational speed of the printhead 220 ranges from 0 to 3,000 RPM, inclusive.

The printhead 220 can be highly versatile in its operation. For example, the rotation controller 212 can dynamically adjust (e.g., increase or decrease) the rotational speed of the printhead 220 white it is actively printing, allowing for precise control of the printing process. In some examples, the rotation controller 212 can reverse the rotation direction (e.g., from clockwise to counterclockwise, or vice versa) of the printhead 220 on the fly. For instance, the rotation controller 212 can control repeatedly reverse the rotation direction of the printhead 220 during operation so that the printhead can exhibit oscillatory motion. Such oscillatory motion can be leveraged to achieve specific printing effects and/or to enhance the overall printing quality.

The printhead 220 can have or be coupled with one or more fluid dispensers 231 which can define multiple outlets 230. The fluid dispensers 231 can be nozzles, needles, spinneret, or the like.

In some examples, each fluid dispenser 231 can have a distal opening that defines a respective outlet 230. For example, FIG. 2 shows three fluid dispensers 231 which respectively define three outlets 230. In some examples, the printhead 220 can have or be coupled with two or more than three (e.g., 4, 5, 6, etc.) fluid dispensers 231, thus resulting in two or more than three outlets 230.

In some examples, one fluid dispenser 231 can define multiple outlets 230. For instance, one fluid dispenser 231 can have multiple spaced-apart distal openings, each of which can define a corresponding outlet 230.

In some examples, a polymer jet 202 (e.g., a polymer melt) can be ejected from each outlet 230. The polymer jets 202 ejected from the outlets 230 can be electrically charged, as described further below. Spinning the printhead 220 can cause corresponding rotation of the fluid dispensers 231 (and the outlets 230) around the longitudinal axis 208. As a result, the polymer jets 202 ejected from the outlets 230 can form spiral trajectories and such spiral polymer jets 202 can intertwine with each other.

As described herein, the rotational speed of the printhead 220 can be configured to cause the polymer jets 202 ejected from the multiple outlets 230 to intertwine midair before depositing on a collector or substrate 280 that is situated at an operating distance from the outlets 230. As described herein, the term “midair” refers to any part or section of a medium (including air, any gas mix, or vacuum) between the outlets 230 and the substrate 280. For example, FIG. 2 schematically illustrates that three electrically charged polymer jets 202 can be twisted together midair to form a combined jet 204 before reaching the substrate 280. The combined jet 204 can be solidified midair and/or on the substrate 280, and then deposited on the substrate 280 to form three-filament fibers 206 in which each filament is formed from a corresponding polymer jet 202. Generally, N-filament fiber comprising N filaments or strands can be produced by twisting polymer jets ejected from N outlets 230, wherein N≥2.

In some examples, the multiple outlets 230 can be positioned circumferentially symmetric about the longitudinal axis 208 of the printhead 220 (e.g., the three outlets 230 can be 120 degrees apart from one another). In other examples, the multiple outlets 230 can be positioned circumferentially asymmetric about the longitudinal axis 208.

As described herein, a distance between two adjacent outlets 230 is referred to as an inter-outlet distance. In some examples, the inter-outlet distance can range from 0 mm to 5 mm, inclusive. In some examples, one or more of the fluid dispensers 231 can be bent toward or away from the longitudinal axis 208 or in other directions to adjust the inter-outlet distance. The inter-outlet distance can be a fraction of the operating distance between the outlets 230 and the substrate 280, and such fraction can range from 5% to 200%, inclusive. In some examples, the multiple outlets 230 are spaced azimuthally with equal, unequal, or other angular separations at one or more radial distances from the longitudinal axis 208. In other examples, the multiple outlets 230 include outlets at a plurality of radial distances form the longitudinal axis 208 at one or more azimuthal angles. Other configurations can also be used. For instance, the multiple outlets 230 can be arranged in a rectangular array or to correspond to vertices of one or more polygons. In some examples, one of the outlets 230 can be situated on the longitudinal axis 208. When one of the outlets 230 is situated on the longitudinal axis 208, it opens up the possibility of creating complex structures like wires. For instance, a central core filament could be made from one material, while twisted filaments around the central core element could be made from another material. This configuration not only can offer a unique way to create multi-material structures, but also could potentially add extra features to the printed structures, such as enhanced strength, flexibility, or functionality, depending on the materials used.

In some examples, the multiple outlets 230 can have the same inner diameter. In other examples, the outlets 230 can have different inner diameters or different shapes so that the diameter of polymer jets ejected from those outlets 230 can vary. In some examples, the inner diameter of the outlets 230 can range from 0.01 mm to 5 mm, inclusive. In one specific example, the inner diameter of the outlets 230 ranges from 0.01 mm to 0.5 mm, inclusive. In another specific example, the inner diameter of the outlets 230 ranges from 0.05 mm to 2 mm, inclusive.

As shown in FIG. 2, the one or more fluid dispensers 231 can extend out of a bottom surface 224 of the printhead 220 (toward the substrate 280) so that the outlets 230 are spaced apart from the bottom surface 224. The axial length of the fluid dispensers 231 extending out of the printhead 220 can be a fraction of the operating distance between the outlets 230 and the substrate 280, and such fraction can range from 0% to 99%, or from 20% and 50%, all inclusive. Also, the axial length of the fluid dispensers 231 extending out of the printhead 220 can be the same or different.

In other examples, the one or more fluid dispensers 231 may not extend out of the printhead 220. Instead, the one or more fluid dispensers 231 may be embedded within the printhead 220 so that the multiple outlets 230 are located at (or be flush with) the bottom surface 224 of the printhead 220.

The electrohydrodynamic processing system 200 can include at least one container or reservoir 240 in fluid communication with the fluid dispenser(s) 231 and the multiple outlets 230. The at least one reservoir 240 is configured to hold fluid or liquid (e.g., polymer melt) which can be ejected through the outlets 230.

In some examples, there can be multiple reservoirs 240, each of which is fluidly connected to a respective outlet 230. In such configurations, different reservoirs 240 can contain different liquids or the same liquids. For example, liquids in different reservoirs can contain different polymers or have a polymer having different physical and/or chemical properties (e.g., with different polymer concentrations, or the same polymer with different additives such as particles, fluorophores, drugs, etc.). In other examples, the multiple outlets 230 can be fluidly connected to one reservoir 240 so that the same reservoir 240 can supply liquid to the multiple outlets 230.

In some examples, the reservoir(s) 240 can be at least partially retained within the printhead 220. For example, each reservoir 240 can be received within a respective receptacle of the printhead 220. In other examples, the reservoir(s) 240 can be situated away from the printhead 220, and the liquid contained in the reservoir(s) 240 can be transported to the multiple outlets 230 through one or more conduits. In still additional examples, the reservoir(s) 240 and the printhead 220 can be formed as an integral unit (e.g., the reservoir(s) 240 can be fixedly embedded within the printhead 220).

In some examples, a fluid dispenser 231 (including an outlet defined by the fluid dispenser) and the corresponding reservoir 240 can be separable or integral components of an article, such as a syringe. For example, a barrel of the syringe can be the reservoir 240 and a needle of the syringe can be the fluid dispenser defining an outlet 230.

In some examples, the fluid dispenser(s) 231 and the corresponding reservoir(s) 240 can be detachably connected. For example, the fluid dispenser(s) 231 can be removably connected to the corresponding reservoir(s) 240 via Luer-lock, press-fit, friction-fit, screwing, etc. Once connected, fluid communication between the reservoir(s) 240 and the outlets 230 defined by the fluid dispenser(s) 231 can be established.

In some examples, the fluid dispenser(s) 231 (including the outlets 230 defined by the fluid dispenser(s)) can be integral components of the printhead 220. When the reservoirs 240 are inserted into corresponding receptacles of the printhead 220, the fluid dispenser(s) 231 (and the outlets 230) can be fluidly connected to the reservoirs 240 via any of connection mechanism described above.

The electrohydrodynamic processing system 200 can include at least one pressure source 250 (e.g., a piston, pump, plunger, nitrogen canister, etc.) configured to pressure or extrude the liquid out of the reservoir(s) 240 through the multiple outlets 230. In some examples, multiple reservoirs 240 can share the same pressure source 250 so that equal pressure can be applied by the pressure source 250 to the multiple reservoirs 240. In some examples, the shared pressure source 250 can be coupled to a rotatory union which can rotate together with the printhead 220 (and in the same rotational speed). In other examples, each reservoir 240 can have a corresponding pressure source 250 so that the pressure applied within each reservoir 240 can be independently controlled. In still other examples, conduits or other fluidic components are situated so that a single pump can be used to provide different pressures to at least some of the multiple outlets. As shown in FIG. 2, the pressure source(s) 250 can be operatively connected to a pressure controller 214 configured to adjust the pressure applied by the pressure source(s) 250. In some examples, the pressure applied by the pressure source(s) 250 can range from 0 to 50 bar, inclusive. In one specific example, the pressure applied by the pressure source(s) 250 can range from 0 to 4 bar, inclusive.

In the depicted example, the electrohydrodynamic processing system 200 further includes a thermo-regulating device 260 (which can also be referred to as a “heating apparatus”), which can be configured to heat the liquid in the reservoir(s) 240. Particularly, for melt electrospinning, melt electrowriting, or melt electrospraying, the liquid in each reservoir 240 is a polymer melt. The thermo-regulating device 260 can be configured to heat a polymer in the reservoir 240 to an operating temperature that is above a melting point of the polymer so that the polymer becomes the polymer melt. Conduits that deliver the liquid from the reservoir(s) 240 to the outlets 230 can also be heated.

In some examples, heating of the polymer in the reservoir(s) 240 can be achieved via conductive coupling to the reservoir(s) 240 (e.g., when the reservoir 240 and printhead 220 are made of heat conductive materials). Additionally, and/or alternatively, heating of the polymer in the reservoir(s) 240 can be achieved by other heat transfer mechanisms, such as convection and/or radiation.

In some examples, the thermo-regulating device 260 can be operatively coupled to the printhead 220. For example, as shown in FIG. 2, the thermo-regulating device 260 can surround the printhead 220 like a jacket and heat the reservoir(s) 240 retained within the printhead 220. In cases where the reservoir(s) 240 are situated away from the printhead 220, the thermo-regulating device 260 can also be spaced apart from the printhead 220. In such cases, the thermo-regulating device 260 can be configured to maintain the operating temperature within the reservoir(s) 240 and the conduits connecting the reservoir(s) 240 to the multiple outlets 230 so that the polymer therein remains in the molten state.

As shown in FIG. 2, the thermo-regulating device 260 can be operatively connected to a temperature controller 216 configured to maintain the operating temperature, e.g., by using a proportional, integral, and derivative (PID) temperature control mechanism. In some examples, thermostats or other types of temperature sensors can be used to measure the temperature within the reservoir(s) 240, and the temperature controller 216 can be configured to control the heating to ensure the temperature within the reservoir(s) 240 and at the outlets 230 remains as close as possible to the operating temperature. In some examples, the temperature controller 216 is configured to maintain the operating temperature from 26 C.° to 500 C°, inclusive.

Although in the examples described herein the operating temperature is achieved via heating the liquid contained in the thermo-regulating device 260, it should be understood that the liquid contained in the thermo-regulating device 260 can also be cooled to a desired temperature (e.g., controlled by the temperature controller 216) in certain circumstances. For example, certain biomaterials used in 3D printing could be maintained at a temperature that is as low as −30 C°. The cooling can be achieved via a variety of means (e.g., using Peltier devices, chillers, liquid nitrogen, etc.).

The electrohydrodynamic processing system 200 further includes a power supply 270 configured to generate an electrostatic field between the multiple outlets 230 and the substrate 280. The generated electrostatic field can have a sufficiently high voltage (also referred to as an “accelerating voltage”) to electrically charge the polymer jets 202 ejected out of the outlets 230 and direct the electrically charged polymer jets 202 to the substrate 280. As described above, spinning or rotation of the printhead 220 can cause the electrically charged polymer jets 202 to intertwine with each other to form a combined jet 204 before depositing on the substrate 280 and solidify into multi-filament fibers 206 (e.g., as in melt electrospinning or melt electrowriting).

The power supply 270 can provide either direct current (DC) or alternating current (AC). For DC power, the outlets 230 can be positively charged and the substrate 280 can be grounded, or vice versa. Alternatively, a differential voltage can be applied between the outlets 230 and the substrate 280, while neither the outlets 230 nor the substrate 280 is grounded. Both the outlets 230 and the substrate 280 can comprise conductive materials such as metals. For example, the outlets 230 can comprise stainless steel, or the like. In some examples, the power supply 270 can be operatively connected to a voltage controller 210 which is configured to program and/or adjust the accelerating voltage. In some examples, the accelerating voltage generated by the power supply 270 can range from 0.1 kV to 50 kV, or from 0.1 kV to 10.2 kV, all inclusive. In one specific example, the accelerating voltage is about 5 kV. In some examples, the electrostatic field and/or the accelerating voltage generated between the outlets 230 and the substrate 280 can be time varying.

The operating distance between the outlets 230 and the substrate 280 can be less than 30 mm, or less than 20 mm in some instances. For example, for electrowriting, the operating distance can be between 0.05 mm and 10 mm, or between 1 mm and 5 mm, all inclusive.

In some examples, the substrate 280 and the printhead 220 can be configured to be movable relative to one another. In the example depicted in FIG. 2, the substrate 280 is operatively connected to a motion controller 218, which can translate the substrate 280 relative to the printhead 220. In some examples, the translational speed of the substrate 280 can range from 0 to 10,000 mm/min, inclusive. In other examples, the substrate 280 can be stationary whereas the printhead 220 can be configured to translate (besides rotation movement) relative to the substrate 280.

The relative movement between the printhead 220 and the substrate 280 can be multi-directional. In one example, the substrate 280 can be translated in an X-Y plane that is perpendicular to the longitudinal axis 208 (or Z-axis) of the printhead 220. In another example, the substrate 280 can be moved along the Z-axis (e.g., moving closer to or farther away from the printhead 220). In yet additional examples, the substrate 280 can be configured to rotate in a plane (e.g., in the X-Y plane, etc.) or spin around an axis (e.g., around the X-axis, etc.).

In the example depicted in FIG. 2, the substrate 280 has a planar surface. In other examples, the substrate 280 can have a curved surface (e.g., over a cylindrical mandrel, etc.) or other non-planar surfaces having multiple heights.

The direction of the polymer jets 202 (and the combined jet 204) is generally controlled by the electrostatic field established between the outlets 230 and the substrate 280. In the example depicted in FIG. 2, the printhead 220 is oriented in the vertical direction and the substrate 280 is located below the printhead 220. In other examples, the printhead 220 can be oriented in other directions. For example, the longitudinal axis 208 can be tilted so that the outlets 230 point sideways. Or the printhead 220 can be flipped upside down so that the outlets 230 point upward. The substrate 280 can be arranged accordingly (e.g., located on a side of or above the printhead 220) so long as the electrostatic field can direct the polymer jets 202 (and the combined jet 204) toward the substrate 280.

In some examples, the multi-filament fibers 206 can be deposited on the substrate 280 to form a single-layer membrane or form a multi-layer 3D structure or scaffold. Movement of the substrate 280 relative to the printhead 220 can be precisely controlled (e.g., by the motion controller 218) so that the resulting 3D structure or scaffold can have a desired geometry.

Generally, multi-filament fibers are stronger than single-filament fibers of the same material due to improved load distribution and inter-filament interactions. In multi-filament fibers, the load is distributed across multiple filaments, reducing stress concentration and enhancing overall strength. Additionally, inter-filament bonding and entanglements can further reinforce the structure, increasing resistance to breakage. In contrast, single-filament fibers lack these mechanisms, making them more susceptible to failure under stress, resulting in lower strength compared to their multi-filament counterparts. Thus, membranes or scaffolds fabricated using multi-filament fibers produced by the electrohydrodynamic processing system 200 can have improved mechanical strength compared to membranes or scaffolds fabricated using single-filament fibers produced by conventional electrohydrodynamic processing systems.

As described above, polymer jets (e.g., polymer melts) ejected from different outlets 230 can comprise different polymer materials, or the same polymer material with different properties (e.g., strength, stiffness, plasticity, friction, thermal resistance, moisture absorption, diameter, color, etc.). Thus, multi-filament fibers produced by the electrohydrodynamic processing system 200 can be customized to achieve desired properties, offering more fabrication flexibility than single-filament fibers produced by conventional electrohydrodynamic processing systems.

In some examples, the multiple outlets 230 on the printhead 220 can be positioned in such a close proximity such that the polymer melts extruded through the multiple outlets can merge into a shared molten polymer drop. This configuration is schematically illustrated in FIG. 2A, which shows the printhead 220 with three fluid dispensers 231 that are arranged in close proximity with each other (other components of the electrohydrodynamic processing system 200 are omitted for clarity). In some cases, some or all of the fluid dispensers 231 can even contact one another. As a result, the outlets 230 of the fluid dispensers 231 are positioned so closely together that the polymer melts extruded from each outlet 230 can converge, forming a single, shared molten polymer droplet 233. Under the electrostatic field generated by the power supply 270, the shared molten polymer droplet 233 can be stretched from its initial spherical shape (indicated by a dashed circle) to a conical shape, thereby forming a Taylor cone 235. When the strength of the electrostatic field is high enough, the electric field force can overcome the surface tension of the shared molten polymer droplet 233 and cause an electrically charged polymer jet 114 to be ejected from the Taylor cone 235. Similarly, the electrically charged polymer jet 114 can be directed toward and deposited on the substrate 280 to form a polymer fiber. In some examples, polymer melts extruded through different outlets 230 can contain different polymer materials (or the same polymer material with different physical and/or chemical properties). As such, despite only a single polymer jet 114 is generated from the shared molten polymer droplet 233, the resulting polymer fiber can contain different polymer materials and/or a polymer material with different properties. In some examples, the printhead 220 can be rotated (as described above) so that the resulting polymer fiber can be twisted along its longitudinal axis.

Although FIG. 2 shows multiple controllers (e.g., voltage controller 210, rotation controller 212, pressure controller 214, temperature controller 216, and motion controller 218), it should be understood that some or all of the depicted controllers can be integrated within one unitary control module.

Although melt electrowriting and melt electrospinning are described above to illustrate the electrohydrodynamic processing system 200 (e.g., the liquids in the reservoirs 240 are polymer melts), it should be understood that the electrohydrodynamic processing system 200 can also be used for solution electrospinning and/or solution electrowriting (e.g., the liquids in the reservoirs 240 are polymer solutions). Additionally, the electrohydrodynamic processing system 200 can also be used for solution electrospraying and/or melt electrospraying (e.g., the liquids in the reservoirs 240 are solutions of or molten low surface tension polymers). For solution-based electrohydrodynamic processes, the thermo-regulating device 260 may be optional.

Further, the electrohydrodynamic processing system 200 can be configured to combine two or more different electrohydrodynamic processes. For example, one heated reservoir can contain a polymer melt which is ejected from a first subset of the outlets (e.g., as in melt electrowriting or melt electrospinning), whereas another reservoir can contain a polymer solution which is ejected from a second subset of the outlets (e.g., as in solution electrospinning or solution electrowriting). Rotation of the printhead 220 can cause the polymer jets formed from both the first and second subsets of the outlets to twist midair before being deposited on the substrate as solidified multi-filament fibers.

Further, the electrohydrodynamic processing system 200 can be integrated with the heated solution electrospinning system described in U.S. patent application Ser. No. 18/500,960, which is incorporated by reference herein in its entirety.

### Example Printhead Assembly

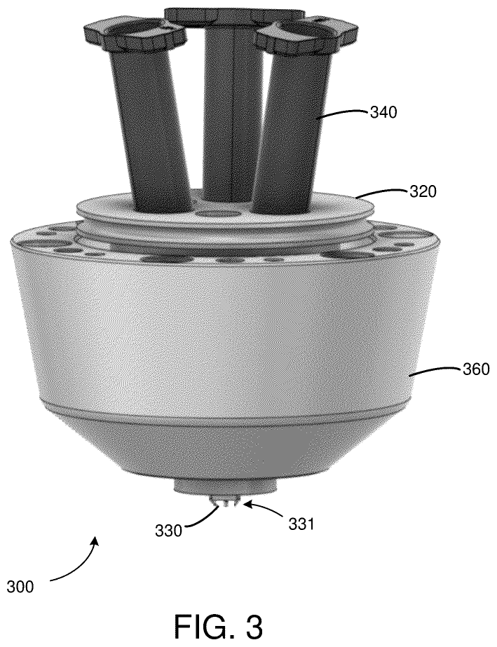

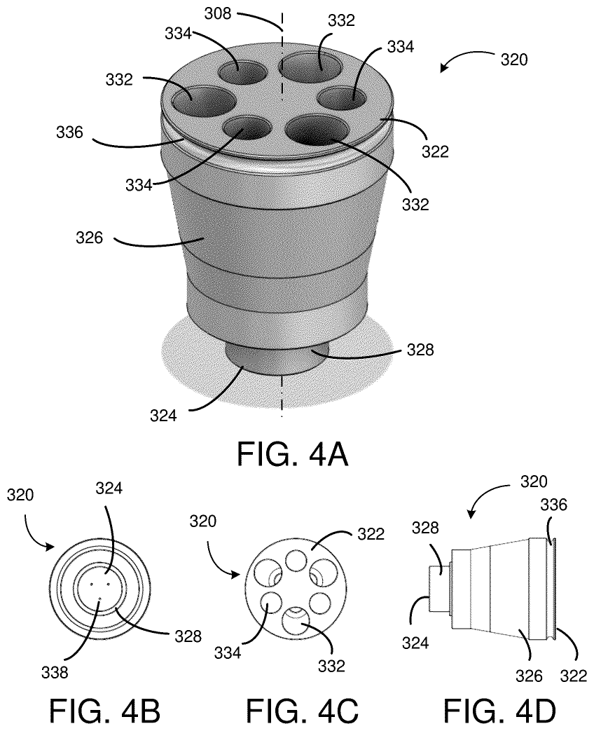

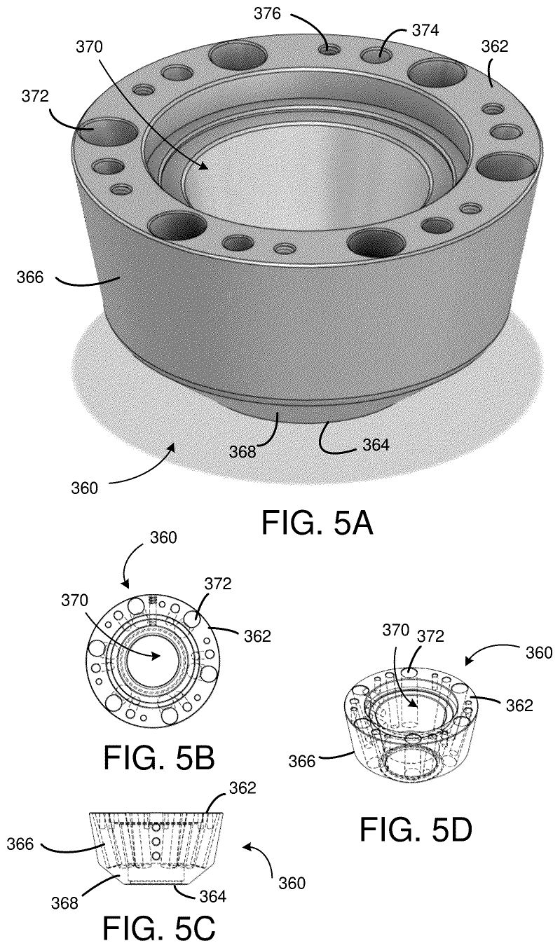

FIG. 3 shows a printhead assembly 300 which can be used in the electrohydrodynamic processing system 200 of FIG. 2, according to one example. The printhead assembly 300 includes a printhead 320 (similar to the printhead 220) and a thermo-regulating device 360 (similar to the thermo-regulating device 260) surrounding the printhead 320. The printhead 320 can spin or rotate about its longitudinal axis within the thermo-regulating device 360. More detailed structure of the printhead 320 is shown in FIGS. 4A-4D. More detailed structure of the thermo-regulating device 360 is shown in FIGS. 5A-5D. It should be understood that the printhead 320 and the thermo-regulating device 360 depicted herein are merely exemplary. For example, the printhead 320 and/or the thermo-regulating device 360 can have different shapes, sizes, and/or configurations than the ones shown in FIGS. 3, 4A-4D, and 5A-5D.

As shown in FIG. 3, a plurality of fluid dispenser 331 (similar to the fluid dispensers 231) can extend out of the printhead 320, each of which can define an outlet 330. A plurality of containers or reservoirs 340 (similar to the reservoirs 240) can be retained by the printhead 320. Each reservoir 340 can be fluidly coupled to a respective fluid dispenser 331 (and the corresponding outlet 330). In the example depicted in FIG. 3, three outlets 330 (defined by three fluid dispensers 331) and three reservoirs 340 are shown. Each fluid dispenser 331 can be a needle of a syringe and the corresponding reservoir 340 can be a barrel of the syringe.

In other examples, the number of outlets 330 can be two or more than three, the number of fluid dispensers 331 can be one, two, or more than three, and the number of reservoirs 340 can also be one, two, or more than three. As one example, a single reservoir 340 can be fluidly coupled with two or more fluid dispensers 331, each of which defines a respective outlet 330. As another example, a single reservoir 340 can be fluidly coupled with a single fluid dispenser 331, which can define two or more outlets 330.

In some examples, each fluid dispenser 331 can be detachably attached to a corresponding reservoir 340. In some examples, the fluid dispensers 331 (and the corresponding outlets 330) can be integral components of the printhead 320, and insertion of the reservoirs 340 into the printhead 320 can cause the reservoirs 340 to be fluidly coupled to the fluid dispensers 331, thereby establishing fluid communication between the outlets 330 and the corresponding reservoirs 340.

Each reservoir 340 can hold a fluid or liquid (e.g., a polymer melt) which can be heated by the thermo-regulating device 360. The liquid in each reservoir 340 can be ejected out of the corresponding outlet 330 (e.g., by applying a pressure to the liquid using a pump) to form a polymer jet. Spinning or rotation of the printhead 320 can cause the polymer jets ejected out of the outlets 330 to intertwine midair before depositing on a substrate or collector, as described above.

As shown in FIGS. 4A-4D, the printhead 320 has two opposing surfaces: a top surface 322 and a bottom surface 324 (facing the substate). The printhead 320 has a body portion 326 defining the top surface 322 and a neck portion 328 defining the bottom surface 324. The body portion 326 can have a tapered tube shape with a diameter progressively decreasing from the top surface 322 toward the neck portion 328. The neck portion 328 can have a generally cylindrical shape.

A circumferential groove 336 can be located at the top edge of the body portion 326 adjacent the top surface 322. The groove 336 can be configured to receive a belt connected to a drive pulley which is driven by a motor. Activation of the motor can rotate the drive pulley, which can pull the belt, thereby causing the printhead 320 to rotate about its longitudinal axis 308. Other rotation actuators (e.g., timing belt, gears, etc.) can also be used to spin the printhead 320.

The printhead 320 includes a plurality of receptacles 332 (three are shown in FIG. 4A) configured to receive respective reservoirs 340. As shown in FIG. 4B, the printhead 320 has three openings 338 located at the bottom surface 324, through which the fluid dispensers 331 (and the outlets 330) can extend out of the printhead 320.

In some examples, the printhead 320 optionally can have additional hollow recesses 334. The size and position of such recesses 334 can be configured to reduce the overall weight of the printhead 320 and keep a uniform mass distribution to ensure spinning symmetry (e.g., avoid wobbling) of the printhead 220.

As shown in FIGS. 5A-5D, the thermo-regulating device 360 can have two opposing surfaces: a top surface 362 and a bottom surface 364. The body of the thermo-regulating device 360 can have a top portion 366 and a bottom portion 368, the bottom portion 368 generally having a smaller diameter than the top portion 366. The thermo-regulating device 360 has a central cavity 370 through which the printhead 320 can be inserted.

In some examples, the thermo-regulating device 360 can be fixedly coupled to the printhead 320 (e.g., via press-fitting, fastening, clipping, or other attachment means). As a result, spinning of the printhead 320 can also cause rotation of the thermo-regulating device 360. In other examples, the thermo-regulating device 360 can be detached from the printhead 320 such that the thermo-regulating device 360 can remain stationary while the printhead 320 spins within the thermo-regulating device 360.

The top portion 366 can have a frustoconical shape which has a larger top surface 362 and tapers toward the bottom portion 368. The top portion 366 can be configured to surround the body portion 326 of the printhead 320. The bottom portion 368 can also have a frustoconical shape with a progressively increasing diameter from the bottom surface 364 toward the top portion 366. The bottom portion 368 can be configured to surround the neck portion 328 of the printhead 320.

In some examples, the thermo-regulating device 360 can include a plurality of first cells 372 (e.g., six large-size cells 372 are shown in FIG. 5A) configured to receive heating elements (e.g., resistance heating coils, infrared heaters, etc.). The position of the first cells 372 can be configured so that liquids in the reservoirs 340 can be uniformly or substantially uniformly heated to a desired operating temperature.

In some examples, the thermo-regulating device 360 can include a plurality of second cells 374 (e.g., six mid-size cells 374 are shown in FIG. 5A) configured to hold temperature sensors (e.g., thermistors, thermocouples, etc.). The temperature sensors can be used to measure temperature of the liquids contained in the reservoirs 340. As described above, a temperature controller can use a PID control mechanism to maintain the operating temperature of the liquid in the reservoirs 340 (e.g., by measuring the temperature using the temperature sensors and adjusting the output of the heating elements).

In some examples, the thermo-regulating device 360 can further include a plurality of third cells 376 (e.g., six small-size cells 376 are shown in FIG. 5A) configured to receive conducting wires (e.g., wires connected to the ground or a high voltage power supply such as 270 of FIG. 2).

The number and/or size of the cells 372, 374, 376 can vary depending on the locations and/or sizes of the reservoirs 340, and/or other considerations.

### Example Prototype

A prototype has been developed to test the electrohydrodynamic processing technologies described herein.

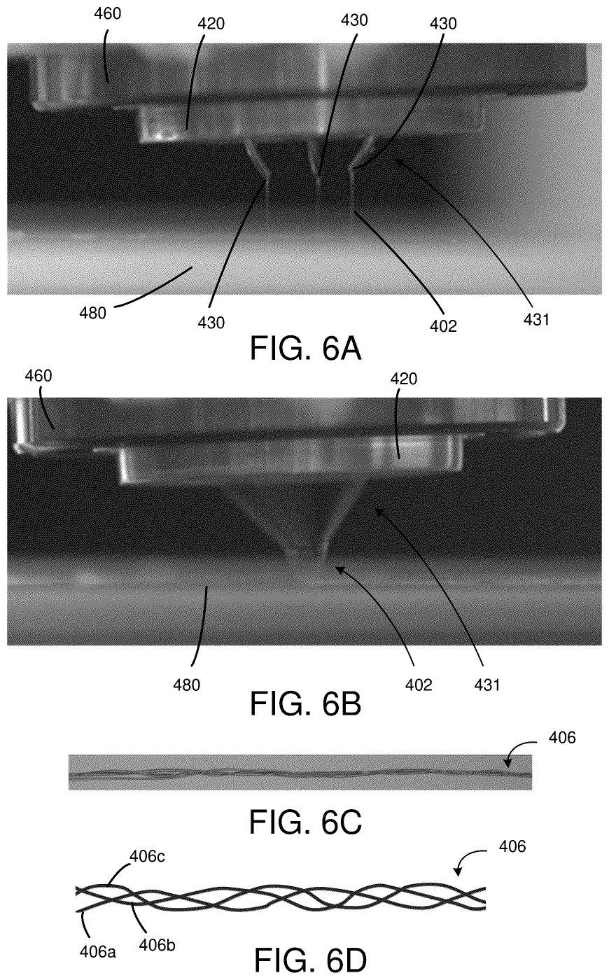

FIG. 6A is a photo of a rotatable printhead 420 and three fluid dispenser 431 (defining three outlets 430) included in a prototype electrohydrodynamic processing system, according to one example. The printhead 420 is surrounded by a thermo-regulating device 460. In this example, polymer polycaprolactone (PCL) is contained in reservoirs that are in fluid communication with the outlets 430. The PCL in each reservoir is heated by the thermo-regulating device 460 above its melting point to become a polymer melt. The polymer melts in the reservoirs are then ejected from the outlets 430 to form three polymer jets 402. The polymer jets 402 are electrically charged and drawn to a substrate 480 under a high-voltage electrostatic field established between the outlets 430 and the substrate 480. In FIG. 6A, the printhead 420 does not rotate. As a result, the three polymer jets 402 are generally perpendicular to the substrate 480.

FIG. 6B is a photo showing spinning of the printhead 420. As shown, spinning the printhead 420 causes rotation of the fluid dispensers 431 (and the corresponding outlets 430), which in turn causes midair twisting of the electrically charged polymer jets 402 ejected from the outlets 430.

FIG. 6C shows a SEM image of a fiber segment 406 including three strands of filaments formed by three polymer jets, respectively. FIG. 6D schematically illustrates twisting of the three strands of filaments (406a, 406b, and 406c) to form the fiber segment 406. As described above, twisting of filaments are enabled by the rotation mechanics (e.g., each filament-forming polymer jet forms a spiral trajectory due to spinning of the printhead), which causes intertwinement of the filaments. The rotational speed of the printhead can be configured to be sufficiently large to overcome any electrostatic repulsion force between the filaments so that the filaments can be twisted together.

In some examples, the twisting angle of the produced multi-filament fiber or yarn can be controlled by the translational speed of the substrate as well as the rotational speed of the printhead. More specifically, the fiber is drawn towards the substrate. If the substrate moves at a faster rate than the speed at which the polymer jet is deposited on the substrate, the fiber is mechanically pulled. The angle of twist in the fiber can be determined by the amount of twist (e.g., measured in spinning revolutions per minute, or rpm) and the distance covered (e.g., determined by the translation speed) over a given period of time, provided that the translation speed exceeds the jet speed. If the spinning rpm remains constant and the translation speed is doubled, the twisting angle of the deposited fiber can be reduced by half, and vice versa.

Generally, the higher rotational speed of the printhead, the larger the twist angle. As described herein, the twist angle in a multi-filament fiber refers to the angle formed by the direction of the individual filaments in the fiber with respect to the longitudinal axis of the fiber. The twist angle can be measured in degrees. A larger twist angle is generally associated with a higher twist level (also known as the twist per unit length), which measures the number of turns or twists applied to the fiber per unit length, such as twists per inch (TPI).

In some examples, the rotational speed of the printhead can be varied so that the twist angle and/or twist level of the produced multi-filament fiber can vary along its length. Because the twist angle of a fiber may affect many properties of the fiber (e.g., strength, flexibility, elasticity, diameter, etc.), the electrohydrodynamic processing technologies described herein can produce multi-filament fiber of desired properties even with a single polymer.

As described above, by ejecting polymer jets comprising different polymer materials (or the same polymer material with different properties), the electrohydrodynamic processing technologies described herein can flexibly impart desired properties to the produced fibers, which can be used to create custom scaffolds or other 3D structures.

### Example Printing Method

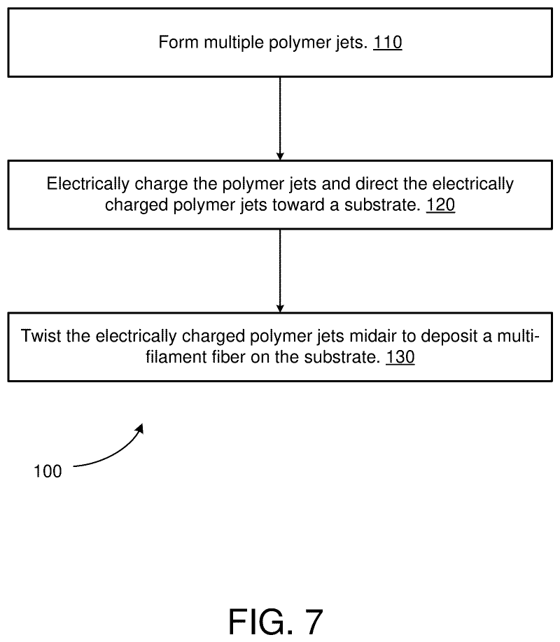

FIG. 7 is a flowchart describing an example printing method, according to certain aspects of the disclosed technologies.

At 710, the method 700 can form multiple polymer jets. For example, multiple outlets (e.g., the outlets 230 or 330) can be connected to a printhead (e.g., the printhead 220 or 320). A polymer in liquid form contained in one or more reservoirs (e.g., the reservoirs 240 or 340) can be ejected from the outlets to form the polymer jets (e.g., the polymer jet 202 of FIG. 2). For melt electrospinning, melt electrowriting, or melt electrospraying, the polymer can be heated to an operating temperature that is above a melting point of the polymer so that the polymer becomes a polymer melt. The polymer jets can be formed by ejecting the polymer melts through the multiple outlets.

At 720, the ejected polymer jets can be electrically charged and then directed toward a substrate (e.g., the substrate 280). This can be accomplished, e.g., by creating a high-voltage electrostatic field between the multiple outlets and the substrate (e.g., by activating the power supply 270).

At 730, the electrically charged polymer jets can be twisted midair to deposit a multi-filament fiber (e.g., the fiber 206) on the substrate. This can be accomplished, e.g., by spinning or rotating the printhead at a sufficiently high rotational speed so that the polymer jets form spiral trajectories and intertwine with each other.

In some examples, the multi-filament fiber can be deposited on specific locations of the substrate to form a desired pattern or geometry, e.g., by moving the substrate relative to the printhead, as described above.

In some examples, the method 700 can further include forming a 3D structure using the above produced multi-filament fiber, e.g., by depositing the multi-filament fiber on the substrate in multiple layers, as described above.

### Example Computing Systems

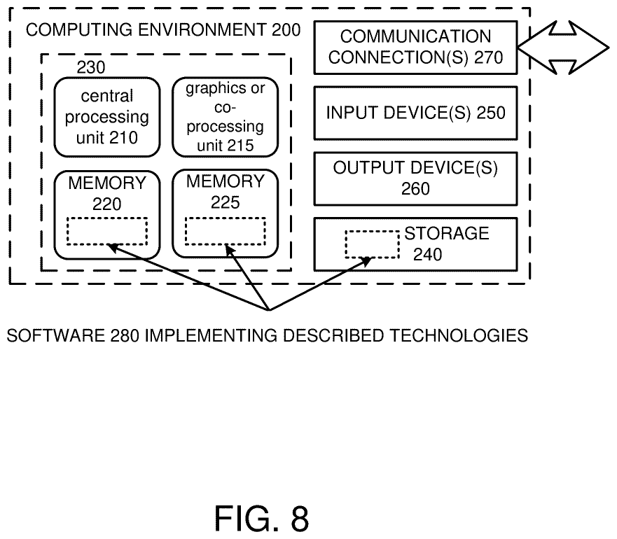

FIG. 8 depicts an example of a suitable computing system 800 in which the described innovations can be implemented. For example, the computing system 800 can be used in any of the controllers (e.g., the controllers 210, 212, 214, 216, 218) depicted in FIG. 2. The computing system 800 is not intended to suggest any limitation as to scope of use or functionality of the present disclosure, as the innovations can be implemented in diverse computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 can be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 880 implementing one or more innovations described herein, in the form of computer-executable instructions suitable for execution by the processing unit(s) 810, 815.

A computing system 800 can have additional features. For example, the computing system 800 includes storage 840, one or more input devices 850, one or more output devices 860, and one or more communication connections 870, including input devices, output devices, and communication connections for interacting with a user. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 can be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software implementing one or more innovations described herein.

The input device(s) 850 can be an input device such as a keyboard, mouse, pen, or trackball, a voice input device, a scanning device, touch device (e.g., touchpad, display, or the like) or another device that provides input to the computing system 800. The output device(s) 860 can be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various examples. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example Computer-Readable Media

Any of the computer-readable media herein can be non-transitory (e.g., volatile memory such as DRAM or SRAM, nonvolatile memory such as magnetic storage, can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Embodiments

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A device comprising: a rotatable head; and one or more fluid dispensers coupled to the rotatable head, wherein the one or more fluid dispensers define multiple outlets, wherein the one or more fluid dispensers are configured to eject polymer melts through the multiple outlets while rotating the rotatable head about an axis.

Example 2. The device of example 1, wherein there are exactly three outlets.

Example 3. The device of example 2, wherein the three outlets are circumferentially symmetric about the axis.

Example 4. The device of any one of examples 1-3, wherein at least two of the outlets are operable to eject polymer melts comprising two different polymers or a polymer having different properties.

Example 5. The device of any one of examples 1-4, further comprising a thermo-regulating device operatively coupled to the rotatable head, wherein the thermo-regulating device is configured to heat a polymer to an operating temperature that is above a melting point of the polymer so that the polymer becomes the polymer melts.

Example 6. The device of example 5, wherein the rotatable head is received within a cavity of the thermo-regulating device.

Example 7. The device of any one of examples 1-6, further comprising at least one reservoir containing the polymer melts, wherein the at least one reservoir is in fluid communication with the one or more fluid dispensers.

Example 8. The device of example 7, further comprising a pressure source configured to urge the polymer melts from the at least one reservoir out of the multiple outlets.

Example 9. The device of any one of examples 1-8, further comprising a power supply configured to generate an electrostatic field between the multiple outlets and a substrate situated at an operating distance from the multiple outlets, wherein the electrostatic field is configured to electrically charge the polymer melts ejected out of the multiple outlets and draw the electrically charged polymer melts to the substrate.

Example 10. The device of example 9, wherein a rotational speed of the rotatable head is configured to cause the electrically charged polymer melts to intertwine midair before depositing on the substrate.

Example 11. A system comprising: a printhead configured to form polymer jets through multiple outlets; and a power supply configured to generate an electrostatic field between the multiple outlets and a substrate, wherein the electrostatic field is configured to electrically charge the polymer jets and direct the electrically charged polymer jets from the multiple outlets to the substrate, wherein the printhead is configured to cause the electrically charged polymer jets to intertwine midair before depositing on the substrate.

Example 12. The system of example 11, wherein the printhead is rotatable about an axis so as to cause the electrically charged polymer jets to intertwine midair before depositing on the substrate.

Example 13. The system of any one of examples 11-12, wherein the printhead is configured to be situated at an operating distance from the substrate of between 1 mm and 5 mm, inclusive.

Example 14. The system of any one of examples 11-13, further comprising a thermo-regulating device operatively coupled to the printhead, wherein the thermo-regulating device is configured to melt the polymer, wherein the printhead is configured to receive the melted polymer and form the polymer jets from the melted polymer.

Example 15. A method comprising: forming multiple polymer jets; electrically charging the polymer jets and directing the electrically charged polymer jets toward a substrate; and twisting the electrically charged polymer jets midair to deposit a multi-filament fiber on the substrate.

Example 16. The method of example 15, wherein forming the multiple polymer jets comprises ejecting, from each of multiple outlets defined by at least one fluid dispenser, a corresponding polymer melt, wherein the twisting the electrically charged polymer jets comprises rotating the at least one fluid dispenser about an axis.

Example 17. The method of any one of examples 15-16, further comprising heating at least one polymer to an operating temperature that is above a respective melting point to form the respective polymer melt.

Example 18. The method of any one of examples 15-17, further comprising depositing the multi-filament fiber on the substrate in multiple layers.

Example 19. The method of any one of examples 16-19, further comprising moving the substrate with respect to the at least one fluid dispenser while directing the electrically charged polymer jets toward the substrate.

Example 20. The method of example 17, wherein the at least one polymer is a single polymer and each of the polymer jets is formed of the same polymer.

Example 21. An apparatus comprising: a printhead head comprising multiple outlets; a pressure source configured to extrude polymer melts out of the printhead through the multiple outlets; wherein the multiple outlets are positioned on the printhead in such a close proximity that the polymer melts extruded through the multiple outlets merge into a shared molten polymer drop, wherein the polymer melts extruded through at least two of the outlets contain different polymer materials.

Example 22. The apparatus of example 21, further comprising a power supply configured to generate an electrostatic field between the multiple outlets and a substrate, wherein the electrostatic field is configured to generate an electrically charged polymer jet from the shared molten polymer drop and direct the electrically charged polymer jet toward the substrate.

Example 23. The apparatus of any one of examples 21-22, wherein the printhead is configured to be rotatable when extruding the polymer jets.

The technologies from any example can be combined with the technologies described in any one or more of the other examples. In view of the many possible examples to which the principles of the disclosed technology can be applied, it should be recognized that the illustrated embodiments are examples of the disclosed technology and should not be taken as a limitation on the scope of the disclosed technology. Rather, the scope of the claimed subject matter is defined by the following claims and their equivalents.

We claim:

1. A device comprising:
a rotatable head; and
one or more fluid dispensers coupled to the rotatable head,
wherein the one or more fluid dispensers define multiple outlets,
wherein the one or more fluid dispensers are configured to eject polymer melts through the multiple outlets while rotating the rotatable head about an axis.

2. The device of claim 1, wherein there are exactly three outlets.

3. The device of claim 2, wherein the three outlets are circumferentially symmetric about the axis.

4. The device of claim 1, wherein at least two of the outlets are operable to eject polymer melts comprising two different polymers or a polymer having different properties.

5. The device of claim 1, further comprising a thermo-regulating device operatively coupled to the rotatable head, wherein the thermo-regulating device is configured to heat a polymer to an operating temperature that is above a melting point of the polymer so that the polymer becomes the polymer melts.

6. The device of claim 5, wherein the rotatable head is received within a cavity of the thermo-regulating device.

7. The device of claim 1, further comprising at least one reservoir containing the polymer melts, wherein the at least one reservoir is in fluid communication with the one or more fluid dispensers.

8. The device of claim 7, further comprising a pressure source configured to urge the polymer melts from the at least one reservoir out of the multiple outlets.

9. The device of claim 1, further comprising a power supply configured to generate an electrostatic field between the multiple outlets and a substrate situated at an operating distance from the multiple outlets, wherein the electrostatic field is configured to electrically charge the polymer melts ejected out of the multiple outlets and draw the electrically charged polymer melts to the substrate.

10. The device of claim 9, wherein a rotational speed of the rotatable head is configured to cause the electrically charged polymer melts to intertwine before depositing on the substrate.

11. A system comprising:
a printhead configured to form polymer jets through multiple outlets; and
a power supply configured to generate an electrostatic field between the multiple outlets and a substrate,
wherein the electrostatic field is configured to electrically charge the polymer jets and direct the electrically charged polymer jets from the multiple outlets to the substrate,
wherein the printhead is configured to cause the electrically charged polymer jets to intertwine before depositing on the substrate.

12. The system of claim 11, wherein the printhead is rotatable about an axis so as to cause the electrically charged polymer jets to intertwine before depositing on the substrate.

13. The system of claim 11, wherein the printhead is configured to be situated at an operating distance from the substrate of between 1 mm and 5 mm, inclusive.

14. The system of claim 11, further comprising a thermo-regulating device operatively coupled to the printhead, wherein the thermo-regulating device is configured to melt the polymer, wherein the printhead is configured to receive the melted polymer and form the polymer jets from the melted polymer.

15. The system of claim 14, wherein the multiple outlets are positioned on the printhead in such a proximity that the melted polymer exiting the multiple outlets merges into a shared molten droplet, wherein the melted polymer exiting at least two of the outlets contains different polymer materials.

16. A method comprising:
forming multiple polymer jets;
electrically charging the polymer jets and directing the electrically charged polymer jets toward a substrate; and
twisting the electrically charged polymer jets to deposit a multi-filament fiber on the substrate.

17. The method of claim 16, wherein forming the multiple polymer jets comprises ejecting, from each of multiple outlets defined by at least one fluid dispenser, a corresponding polymer melt, wherein twisting the electrically charged polymer jets comprises rotating the at least one fluid dispenser about an axis.

18. The method of claim 16, further comprising heating at least one polymer to an operating temperature that is above a respective melting point to form the respective polymer melt.

19. The method of claim 16, further comprising depositing the multi-filament fiber on the substrate in multiple layers.

20. The method of claim 17. further comprising moving the substrate with respect to the at least one fluid dispenser while directing the electrically charged polymer jets toward the substrate.
